(19) United States
(12) Patent Application Publication
(10) Pub. No.: US 2021/0233402 A1
(43) Pub. Date: Jul. 29, 2021

(54) SECURE TRACKING SYSTEM

(71) Applicants: Hien Nguyen, Missoula, MT (US); Jason Corbally, Missoula, MT (US); Education Logistics, Inc., Missoula, MT (US)

(72) Inventors: Hien Nguyen, Missoula, MT (US); Jason Corbally, Missoula, MT (US)

(21) Appl. No.: 16/972,351

(22) PCT Filed: Jun. 4, 2019
(86) PCT No.: PCT/US2019/035430

§ 371 Date: Dec. 4, 2020

Related U.S. Application Data
(60) Provisional application No. 62/680,489, filed on Jun. 4, 2018.

(51) Int. Cl. G08G 1/127; G08B 21/22

(52) U.S. Cl. CPC G08G 1/127; G08B 21/22

(57) ABSTRACT

A system for securely tracking an entity aboard a vehicle includes a server situated at a first location and a verification system aboard the vehicle, which is configured to determine from an identification device of the entity a first identifier of the entity. The vehicle is at a second location different from the first location. A registration device aboard the vehicle includes a database. The registration device is coupled to the verification system and coupled over a network to the server. The registration device is configured to receive the first identifier from the verification system and determine from the database a second identifier of the entity corresponding to the received first identifier. The registration device is further configured to communicate the second identifier over the network to the server. The registration device does not communicate the first identifier over the network to the server.

### PRIORITY CLAIM

The present application claims priority from U.S. Provisional Patent Appl. No. 62/680,489 titled “SECURE TRACKING SYSTEM” filed Jun. 4, 2018, the contents of which are hereby incorporated by reference in their entirety.

### BACKGROUND

Existing methods of passenger identification work as follows: A vehicle is equipped with a GPS device that sends/receives data through cellular communication and an identification device (typically a radio frequency identification (RFID) reader but could be multiple NFC (Near-Field Communication) options such as smart tags, phones, etc.) connected through a wire to the GPS device. When a passenger boards the vehicle, an NFC device (card or phone) communicates with an NFC reader to begin the identification (ID) process. Upon receipt of the NFC data, the GPS device then transmits the ID located on the card or phone to the GPS device that then sends, wirelessly through a cellular network, to a central location. The ID information is combined with the GPS location data from the vehicle so that a determination can be made as to when and where a passenger has boarded or disembarked a specific vehicle.

Current methods of verifying passenger identities (in school transportation fleets, for example) do not go far enough in creating anonymity for passenger information, thus causing a potential security threat to those passengers. Current methods place the verification and encryption process at a central station, as opposed to at the remote verification device itself; therefore using current methods, data packets sent from the remote location to the central station might reveal sensitive information. A hacker or other interested party, for example, might easily intercept the data as it is being transmitted to the central station, thus allowing for the possibility of revealing who and/or what may be on a given vehicle or on a given route at any time.

Additionally, prior art has relied on the transmission of the ID of the passenger or cargo to first go to base station over a network, allow for verification to happen there, and then provide that feedback to the operator of the vehicle. Prior approaches do not verify and encrypt the data on the verification device itself. This presents security flaws.

### BRIEF DESCRIPTION OF THE DRAWINGS

FIG. 1 is a schematic illustration of a system according to an embodiment of the invention; and

FIG. 2 is a flowchart illustrating a process according to an embodiment of the invention.

### DETAILED DESCRIPTION

This patent application is intended to describe one or more embodiments of the present invention. It is to be understood that the use of absolute terms, such as “must,” “will,” and the like, as well as specific quantities, is to be construed as being applicable to one or more of such embodiments, but not necessarily to all such embodiments. As such, embodiments of the invention may omit, or include a modification of, one or more features or functionalities described in the context of such absolute terms.

Embodiments of the invention may be described in the general context of computer-executable instructions, such as program modules, being executed by a processing device having specialized functionality and/or by computer-readable media on which such instructions or modules can be stored. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

Embodiments of the invention may include or be implemented in a variety of computer readable media. Computer readable media can be any available media that can be accessed by a computer and includes both volatile and nonvolatile media, removable and non-removable media. By way of example, and not limitation, computer readable media may comprise computer storage media and communication media. Computer storage media include volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by a computer. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media. In some embodiments, portions of the described functionality may be implemented using storage devices, network devices, or special-purpose computer systems, in addition to or instead of being implemented using general-purpose computer systems. The term “computing device,” as used herein, refers to at least all these types of devices, and is not limited to these types of devices and can be used to implement or otherwise perform practical applications.

According to one or more embodiments, the combination of software or computer-executable instructions with a computer-readable medium results in the creation of a machine or apparatus. Similarly, the execution of software or computer-executable instructions by a processing device results in the creation of a machine or apparatus, which may be distinguishable from the processing device, itself, according to an embodiment.

Correspondingly, it is to be understood that a computer-readable medium is transformed by storing software or computer-executable instructions thereon. Likewise, a processing device is transformed in the course of executing software or computer-executable instructions. Additionally, it is to be understood that a first set of data input to a processing device during, or otherwise in association with, the execution of software or computer-executable instructions by the processing device is transformed into a second set of data as a consequence of such execution. This second data set may subsequently be stored, displayed, or otherwise communicated. Such transformation, alluded to in each of the above examples, may be a consequence of, or otherwise involve, the physical alteration of portions of a computer-readable medium. Such transformation, alluded to in each of the above examples, may also be a consequence of, or otherwise involve, the physical alteration of, for example, the states of registers and/or counters associated with a processing device during execution of software or computer-executable instructions by the processing device.

As used herein, a process that is performed “automatically” may mean that the process is performed as a result of machine-executed instructions and does not, other than the establishment of user preferences, require manual effort.

An embodiment relates to the field of computer hardware and software, specifically to a method and apparatus for tracking the location and status of people, cargo, vehicles or other types of moving objects that are being boarded, un-boarded, or did not arrive at a certain location. An embodiment also, in real-time and onboard the vehicle, has the planned system's data on a computing device, such as a tablet, and can impart in real-time to the operator of the vehicle any exceptions to what was expected according to the plan.

An embodiment of the invention relates to entity, living or otherwise, attendance tracking and recording methodologies and how they interact with electronic vehicle tracking and management systems to provide secure identity and location verification data from a remote location. An embodiment addresses numerous security issues with existing methods by changing the frequency, type, and/or verification process of entity identity data transmission.

An embodiment has application to any situation where an entity identity needs to be verified at a remote site or vehicle and transmitted (including the use of, but not limited to: GPS, cellular, WIFI, or Internet connections) to a central location, while keeping that identity secure during the transfer process and also providing the operator of the vehicle having real-time feedback on the status, exception, and confirmation of the passenger or cargo that has been boarded. The commercial application for an embodiment includes, but is not limited to: school transportation, fleet management, remote time-clock systems, attendance recording, personnel management, cargo shipments, or any situation where an individual or object may need to be securely identified and/or accounted for at a given location.

An embodiment includes a method of verification and encryption so that data sent wirelessly is secure and unique to an administrator's system while also safely, more efficiently, and avoiding problems in real-time for the operator of the vehicle to know exceptions onboard the tablet.

An embodiment aims to rectify design and security flaws of existing identity verification and tracking systems and introduces a new method and apparatus that can eliminate security concerns inherent with previous methods. An embodiment also provides real-time feedback of any exceptions as well as confirmations to the operator of the vehicle. An embodiment can include an apparatus and method for a location-based, dynamic tracking, identity verification, and notification system with built-in encryption that takes place at the site of the identity verification before the transmission of the data and without regards to the transmission method. This allows users to quickly and accurately identify and account for individuals/objects/cargo at a given location, then anonymize that data before sending it to a central location or other device. By localizing the verification and encryption process to the identity verification device (including, but not limited to, touch screen style tablet computers), an embodiment seeks to make remote verification processes more secure.

An embodiment uses verification and encryptions/anonymity processes to create more secure data transmission. An embodiment performs these tasks on site, sending only randomized data as its transmission. An embodiment utilizes planned data that has unique ID's that are not the same ID located on the card or phone used by the passenger or parcel that has a possibility to be intercepted and compares both onboard and transmits only the administrator-based ID and not the actual ID of the card or phone across a network, such as a wireless network, that could be hacked.

An embodiment provides a software-based, on-vehicle identity verification system including a mobile registration hardware interface (such as a mobile tablet) capable of registering and authenticating passengers and/or cargo without the need to send and receive data packets to a centralized location for identification confirmation. The system uses onboard memory and either or both of wired and wireless hardware to receive and automatically maintain up-to-date databases of passenger/cargo populations and loads, thus allowing on-vehicle confirmation and/or disconfirmation of a boarding or disembarking action. The system uses a GPS/wireless module, a mobile hardware interface, and one or more of visual confirmation by an attendee, communication by the tablet with a short-range wireless-technology (SRWT)-based verification system (using, for example, NFC, Bluetooth, RFID, etc.), or the tablet itself having SRWT verification system capabilities. Alternatively, or additionally, the verification system may have optical scanning capabilities so as to read, for example, barcodes or QR codes or may otherwise be capable of reading magnetic-strip cards.

Each entity may have an identifying device (card (magnetic, smart, barcode), phone, or other appropriate device) that has stored thereon information identifying the entity and that communicates and registers the entity with the verification system. However, the information identifying the entity that is stored on the entity's device is not what is transmitted across a network to a base station, such as a server. Rather, the identifying device is verified by the verification system securely against a planned database of a predetermined set of known entities and stored on the tablet. Subsequently, a unique identifier, different from the identifying information stored on the entity's identifying device and lacking any information that would otherwise identify the entity to third parties, is assigned to the entity. This unique identifier is transmitted to the base station including any exceptions characterizing a status of the entity, such as, but not limited to, wrong bus, wrong stop, wrong route, did not board, etc.

An embodiment includes software and hardware that allow the verification process to take place locally (i.e., it does not require or receive verification from a web-based solution uploaded from a central location), thus providing a more efficient process of verification, allowing for better security protocols, and removing the reliance upon a web-based query to confirm or disconfirm passenger data.

An embodiment includes a web-independent vehicle tracking and identity verification method that can confirm passenger identity and vehicle/passenger location, and time stamp when an individual has boarded or disembarked a specific vehicle. The disadvantages of prior and/or existing approaches include the limited speed of identification verification and a dependence upon web-based data transmission to complete the identity confirmation process, which also creates a security loophole for passenger identification data. An embodiment is comprised of a method of verification that occurs locally on a remote identity verification device of choice, and allows its user to verify identity and location information without the need to communicate with a central station or other web-based query method. For example, a passenger boards a vehicle and uses an RFID card to initialize the verification process. Once initiated, the device communicates with vehicle location hardware (typically GPS) to determine location and compare that person's individual identification data with an on-board software database to determine if the correct passenger has boarded or disembarked at the correct location and time. This information is presented to the user through a GUI. The user receives a confirm/disconfirm message via the GUI in order to relay understandable information regarding each passenger. Additionally, RFID cards and external GPS units are not necessarily required for the verification processes to function. Visual verification by the device user (e.g., the driver of the passenger/delivery vehicle) may substitute as the initiation event and a tablet/device with built-in GPS and verification system may also substitute for the need to communicate with an external GPS unit. An embodiment also addresses security concerns relating to identity data transmission by allowing the encryption of all identity information prior to transmission, if transmission is necessary.

A bus driver, for example, can verify the identity of student passengers boarding the bus and determine if they are the correct student, on the correct bus, at the correct time without the need to contact a central station to verify the data. Again, this also means that if/when the registration device communicates with a central station, the data being sent can be encrypted before transmission to the central station. An administrator verifies on board and does not pass the ID number either in the phone, card, etc. and rather verifies on board and passes a unique ID generated by the registration device. At no point does the card number cross the cellular network to the central/base station.

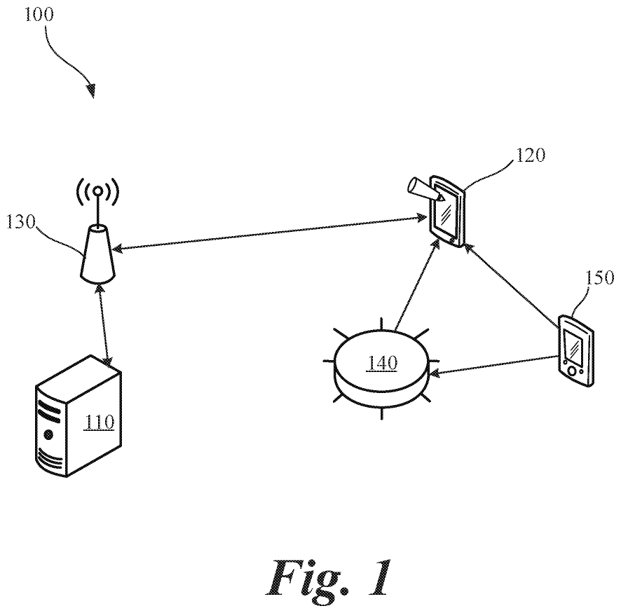

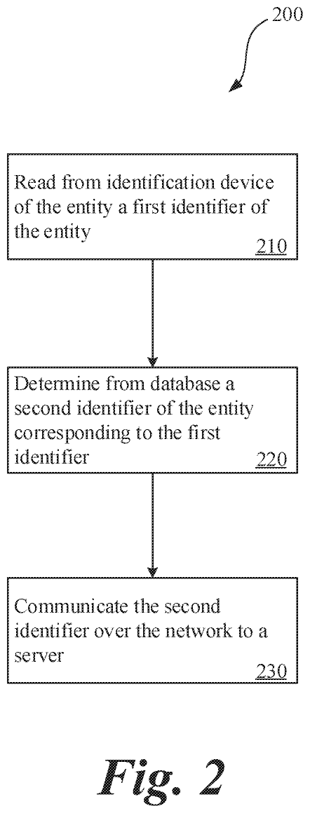

An embodiment includes route management logic wherein transportation staff may utilize software to plan routes (typically planning today for tomorrow's routes). Referring to FIGS. 1-2, a system 100 and process 200 according to an embodiment is as follows:

An administrator of an embodiment wirelessly through WIFI or Cellular network 130 uploads from a server 110 the planned routing data each day (sometimes multiple times per day and/or as changes are made) to an electronic device, such as a tablet 120, onboard a passenger and/or delivery vehicle (not shown). This routing data may include the route that the vehicle will take on such day, the identities of passengers/parcels that are expected to be carried by the vehicle, the expected location at which the passenger/parcel will enter the vehicle, the expected location at which the passenger/parcel will exit the vehicle, as well as the times at which the passenger/parcel are expected to enter and exit the vehicle. This routing data supplied by the server 110 may also include the unique identifiers that will be assigned to the expected passengers/parcels. The upload timing is typically decided by the user of the administrator's route management system. The upload may happen directly to the tablet 120 or the upload passes data through a GPS device 140 to the tablet.

The administrator, at a step 210, then allows passengers to scan their identification device (or in the case of parcels/objects an associated identification device may be scanned), each of which is associated with an ID unique to each passenger (passenger ID), with a verification system device 150, and the reader device then either transmits that data to the GPS device 140 and then to the tablet 120 or directly to the tablet. At a step 220, the tablet 120 then, because it has the planned route management system data, identifies the passenger ID provided to the planned route management system and, at a step 230, sends the unique administrator-generated ID (different from the passenger ID) to the server 110 via the network 130.

An embodiment also provides an indication to the driver of the passenger vehicle, in real-time, that passengers/parcels that have boarded at the wrong location, wrong vehicle, wrong route, wrong stop, and other exceptions only possible with a planned system onboard. The administrator can also pass the exception to the server 110 as opposed to having it processed at the server (the term for this is decentralized processing—having multiple devices process small amounts as opposed to one large device (server) processing all events).

While the preferred embodiment of the disclosure has been illustrated and described, as noted above, many changes can be made without departing from the spirit and scope of the disclosure. Accordingly, the scope of the described systems and techniques is not limited by the disclosure of the preferred embodiment. Instead, the described systems and techniques should be determined entirely by reference to the claims that follow.

The embodiments of the present disclosure in which an exclusive property or privilege is claimed are defined as follows:

What is claimed is:

1. A system for securely tracking an entity aboard a vehicle, comprising:
a server situated at a first location;
a verification system aboard the vehicle and configured to determine from an identification device of the entity a first identifier of the entity, wherein the vehicle is at a second location different from the first location; and
a registration device aboard the vehicle and including a database, the registration device being coupled to the verification system and coupled over a network to the server, the registration device configured to receive the first identifier from the verification system, the registration device further configured to determine from the database a second identifier of the entity corresponding to the received first identifier, the registration device further configured to communicate the second identifier over the network to the server, wherein the registration device does not communicate the first identifier over the network to the server.

2. The system of claim 1, further comprising a GPS module coupled to the registration device.

3. The system of claim 1, wherein the registration device comprises the verification system.

4. The system of claim 2, wherein the registration device comprises the GPS module.

5. The system of claim 1, wherein the registration device comprises a portable electronic tablet.

6. The system of claim 1, wherein the database includes the route that the vehicle will take on a particular day.

7. The system of claim 1, wherein the database includes the identities of entities that are expected to be carried by the vehicle on a particular day.

8. The system of claim 1, wherein the database includes the expected location at which the entities will enter the vehicle on a particular day.

9. The system of claim 1, wherein the database includes the expected location at which the entities will exit the vehicle on a particular day.

10. The system of claim 1, wherein the database includes the times at which the entities are expected to enter and exit the vehicle on a particular day.

11. A method of securely tracking an entity aboard a vehicle, comprising the steps of:
reading, at the vehicle, from an identification device of the entity a first identifier of the entity;
determining, at the vehicle, from a database a second identifier of the entity corresponding to the first identifier;
communicating the second identifier over the network to a server at a location different from a location of the vehicle, wherein the first identifier is not communicated over the network to the server.

12. The method of claim 11, wherein the database includes the route that the vehicle will take on a particular day.

13. The method of claim 11, wherein the database includes the identities of entities that are expected to be carried by the vehicle on a particular day.

14. The method of claim 11, wherein the database includes the expected location at which the entities will enter the vehicle on a particular day.

15. The method of claim 11, wherein the database includes the expected location at which the entities will exit the vehicle on a particular day.

16. The method of claim 11, wherein the database includes the times at which the entities are expected to enter and exit the vehicle on a particular day.
